(19) United States
(12) Patent Application Publication
(10) Pub. No.: US 2004/0232598 A1
(43) Pub. Date: Nov. 25, 2004

(54) Flame resistant thermoplastic composition, articles thereof, and method of making articles

(76) Inventors: Constantin Donea, Evansville, IN (US); Robert R. Gallucci, Mt. Vernon, IN (US); Lyle Kirkpatrick, Cobourg (CA); William Kernick, Evansville, IN (US); Charles Mulcahy, Clarksburg, MA (US); Brian Tande, Mount Vernon, IN (US); Patrick G. Williams, Cobourg (CA)

Correspondence Address: CANTOR COLBURN, LLP, 55 GRIFFIN ROAD SOUTH, BLOOMFIELD, CT, 06002

(21) Appl. No.: 10/441,829

(22) Filed: May 20, 2003

(51) Int. Cl. B29C 43/02; C08K 3/34; B29C 43/52; B29C 45/00; C08J 5/00

(52) U.S. Cl. 264/322; 524/451; 264/328.1; 264/331.11

(57) ABSTRACT

A thermoplastic composition comprising a polyimide resin, a polycarbonate resin, a polyimide-polysiloxane copolymer and talc.

### BACKGROUND OF INVENTION

This disclosure relates to thermoplastic compositions, particularly flame resistant, thermoplastic compositions with good impact strength.

Because of their light weight, durability and strength, engineering thermoplastics are used for the construction of many components of vehicular interiors, including trains cars and aircraft. Components such as wall panels, overhead storage lockers, serving trays, seat backs, cabin partitions and the like are conveniently and economically fabricated by extrusion, thermoforming, injection molding and blow-molding techniques. The thermoplastic resins used in these components, therefore, should be amenable to such fabrication techniques.

Interior components of trains cars and aircraft are regularly subjected to impacts of varying intensities from equipment and luggage. It is very desirable that engineering thermoplastics used for fabricating such parts exhibit impact strength. It is also desirable for the interior components to be manufactured with the desired aesthetic appearance, such as low gloss. Additionally, interior components must meet the transportation industry safety standards for flammability, smoke and toxicity.

Interior components of train cars and aircraft are frequently made by thermoforming. In thermoforming an extruded sheet is warmed to a softening point and fitted to a mold by positive or negative pressure. While an extruded sheet may be embossed to give it texture and low gloss, the texture is frequently lost during the thermoforming process resulting in a high gloss article.

Accordingly, there is a need in the art for a flame resistant thermoplastic composition having impact strength and good aesthetics, even after thermoforming.

### SUMMARY OF INVENTION

Disclosed herein is a thermoplastic composition comprising a polyimide resin, a polycarbonate resin, a polyimide-polysiloxane copolymer and about 1 to about 30 weight percent talc based on the total weight of the composition, wherein the composition has a biaxial impact maximum load greater than or equal to about 975 kilograms per square meter (kg/m²), as measured by ASTM D3763 and a sixty degree gloss less than or equal to about 70, as measured by ASTM D523.

In another embodiment, a method of making an article comprises heating a thermoplastic composition above its softening point and putting the softened thermoplastic composition into a mold, wherein the thermoplastic composition comprises a polyimide resin, a polycarbonate resin, a polyimide-polysiloxane copolymer and about 1 to about 30 weight percent talc based on the total weight of the composition, and the article has a biaxial impact maximum load greater than or equal to about 975 kilograms per square meter, as measured by ASTM D3763 and a sixty degree gloss less than or equal to about 70, as measured by ASTM D523.

The above described composition and method and other features are exemplified by the following figures and detailed description.

### DETAILED DESCRIPTION

Disclosed herein is a thermoplastic composition comprising a polyimide resin, a polycarbonate resin, a polyimide-polysiloxane copolymer and about 1 to about 30 weight percent talc based on the total weight of the composition. The composition has a unique combination of impact strength as evidenced by the biaxial impact maximum load values and excellent aesthetics as demonstrated by sixty degree gloss values. Remarkably, the composition demonstrates low gloss after thermoforming or injection molding in the presence or absence of colorants without the use of texturizing or embossing. Without being bound by theory, the surprising ability of talc to reduce the amount of gloss of the thermally processed composition may be due to the lipophilic nature of talc in contrast to other types of mineral fillers such as clay and titanium dioxide that are hydrophilic. Because talc is lipophilic and the thermoplastic resins are lipophilic it interacts differently with the thermoplastic resins than a hydrophilic filler would. It is believed that the lipophilic nature of the talc aids in the even dispersion of the talc throughout the composition, including the surface where its dispersion gives the composition a uniform low gloss appearance. Additionally, the uniformity of the gloss across the article may be due, in part, to the talc particle size. The talc particles have an average particle size of 40 micrometers or less with greater than or equal to 99% of the talc particles being less than or equal to 50 micrometers.

The composition demonstrates good impact strength as well as heat distortion temperatures. The composition has a biaxial impact maximum load greater than or equal to about 975 kg/m², preferably greater than or equal to about 2,440 kg/m² and most preferably greater than or equal to about 4,880 kg/m², as measured by ASTM D3763. The composition has a heat distortion temperature greater than or equal to about 170° C. at 264 psi as measured by ASTM D648.

In addition, the composition is fire resistant without the use of halogenated fire retardants. Two measures of fire resistance are the OSU two minute heat release value, and the OSU peak heat release value as determined by ASTM E906. To meet some governmental transportation standards a composition must have a two minute heat release and a peak heat release under 65 kilowatt minutes per square meter (kW min/m²). The thermoplastic composition described herein has a two minute heat release of less than or equal to about 10 kW min/m² and preferably less than or equal to about 8 kW min/m² and most preferably less than or equal to about 6 kW min/m². The thermoplastic composition has a peak heat release of less than or equal to about 60 kW min/m² preferably less than or equal to about 55 kW min/m². It additionally desirable for the composition to have an NBS smoke density value of less than or equal to about 10, as determined by ASTM E662.

Thermoplastic polyimides have the general formula (I)

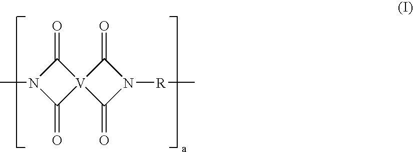

wherein a is more than 1, typically about 10 to about 1000 or more, and more preferably about 10 to about 500; and wherein V is a tetravalent linker without limitation, as long as the linker does not impede synthesis or use of the polyimide. Suitable linkers include but are not limited to: (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations thereof. Suitable substitutions and/or linkers include, but are not limited to, ethers, epoxides, amides, esters, and combinations thereof. Preferred linkers include but are not limited to tetravalent aromatic radicals of formula (II), such as

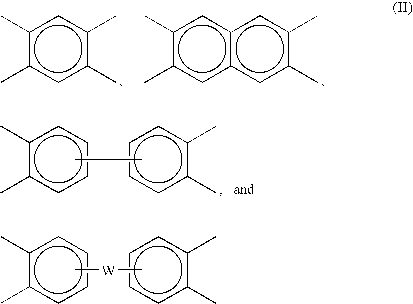

wherein W is a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups, or a group of the formula —O—Z—O— wherein the divalent bonds of the —O— or the —O—Z—O— group are in the 3,3′, 3,4′, 4,3′, or the 4,4′positions, and wherein Z includes, but is not limited, to divalent radicals of formula (III).

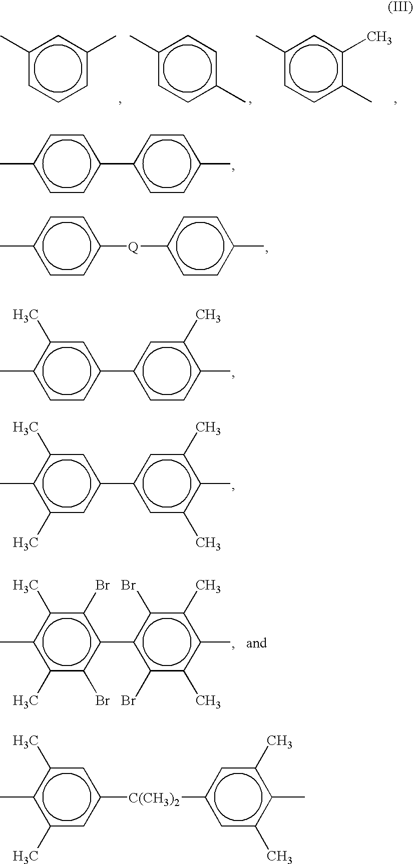

R in formula (I) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (IV)

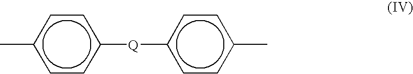

wherein Q includes but is not limited to a divalent moiety selected from the group consisting of —O—, —S—, —C(O)—, —SO₂—, —SO—, —C_{y}H_{2y}— (y being an integer from 1 to 5), and halogenated derivatives thereof, including perfluoroalkylene groups.

Preferred classes of polyimides include polyamidimides and polyetherimides, particularly those polyetherimides known in the art which are melt processible, such as those whose preparation and properties are described in U.S. Pat. Nos. 3,803,085 and 3,905,942.

Preferred polyetherimide resins comprise more than 1, typically about 10 to about 1000 or more, and more preferably about 10 to about 500 structural units, of the formula (V)

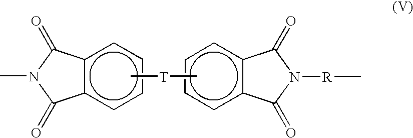

wherein T is —O— or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III) as defined above.

In one embodiment, the polyetherimide may be a copolymer which, in addition to the etherimide units described above, further contains polyimide structural units of the formula (VI)

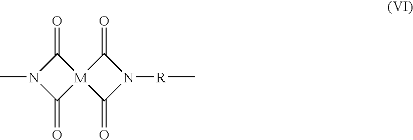

wherein R is as previously defined for formula (I) and M includes, but is not limited to, radicals of formula (VII).

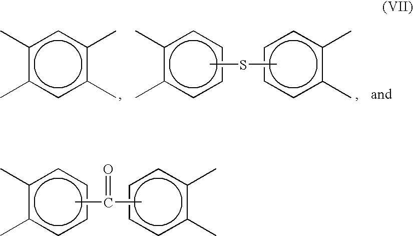

The polyetherimide can be prepared by any of the methods well known to those skilled in the art, including the reaction of an aromatic bis(ether anhydride) of the formula (VIII)

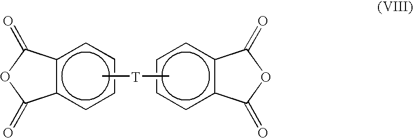

with an organic diamine of the formula (IX)

H₂N—R—NH₂ (IX)

wherein T and R are defined as described above in formulas (I) and (IV).

Examples of specific aromatic bis(ether anhydride)s and organic diamines are disclosed, for example, in U.S. Pat. Nos. 3,972,902 and 4,455,410, which are incorporated herein by reference. Illustrative examples of aromatic bis(ether anhydride)s of formula (VIII) include: 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone - dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A preferred class of aromatic bis(ether anhydride)s included by formula (VIII) above includes, but is not limited to, compounds wherein T is of the formula (X)

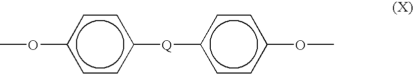

and the ether linkages, for example, are preferably in the 3,3′, 3,4′, 4,3′, or 4,4′ positions, and mixtures thereof, and where Q is as defined above.

Any diamino compound may be employed in the method of this invention. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1,3-diamino-4-isopropylbenzene, bis(4-aminophenyl) sulfide, bis (4-aminophenyl) sulfone, bis(4-aminophenyl) ether and 1,3-bis(3-aminopropyl) tetramethyldisiloxane. Mixtures of these compounds may also be present. The preferred diamino compounds are aromatic diamines, especially m- and p-phenylenediamine and mixtures thereof.

In one embodiment, the polyetherimide resin comprises structural units according to formula (V) wherein each R is independently p-phenylene or m-phenylene or a mixture thereof and T is a divalent radical of the formula (XI)

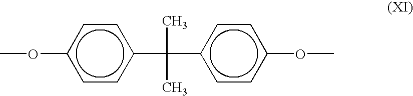

Included among the many methods of making the polyimides, particularly polyetherimides, are those disclosed in U.S. Pat. Nos. 3,847,867, 3,850,885, 3,852,242, 3,855,178, 3,983,093, and 4,443,591. These patents mentioned for the purpose of teaching, by way of illustration, general and specific methods for preparing polyimides.

Polyetherimides have a melt index of about 0.1 to about 10 grams per minute (g/min), as measured by American Society for Testing Materials (ASTM) D1238 at 337° C., using a 6.6 kilogram (kg) weight. In a one embodiment, the polyetherimide resin has a weight average molecular weight (Mw) of about 10,000 to about 150,000 grams per mole (g/mole), as measured by gel permeation chromatography, using a polystyrene standard. Such polyetherimide resins typically have an intrinsic viscosity greater than about 0.2 deciliters per gram (dl/g), preferably about 0.35 to about 0.7 dl/g measured in m-cresol at 25° C. Some such polyetherimides include, but are not limited to ULTEM® 1000 (number average molecular weight (Mn) 21,000; Mw 54,000; dispersity 2.5), ULTEM® 1010 (Mn 19,000; Mw 47,000; dispersity 2.5), ULTEM® 1040 (Mn 12,000; Mw 34,000-35,000; dispersity 2.9), all available from General Electric Plastics.

Polyimide is present in amounts of about 10 to about 90 weight percent, based on the total weight of the composition. Within this range, the amount of polyimide is preferably greater than or equal to about 20, more preferably greater than or equal to about 35, and most preferably greater than or equal to about 35 weight percent. Also within this range, the amount of polyimide is preferably less than or equal to about 85, more preferably less than or equal to about 80 and most preferably less than or equal to about 75 weight percent.

As used herein, the terms “polycarbonate”, includes compositions having structural units of the formula (XII):

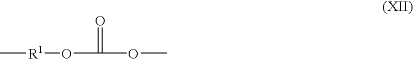

in which at least about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (XIII):

-A¹-Y¹-A²- (XIII)

wherein each of A¹ and A² is a monocyclic divalent aryl radical and Y¹ is a bridging radical having one or two atoms which separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ can be a hydrocarbon group or a saturated hydrocarbon group such as methylene, cyclohexylidene or isopropylidene.

Polycarbonates can be produced by the interfacial or melt polymerization reaction of dihydroxy compounds in which only one atom separates A¹ and A². As used herein, the term “dihydroxy compound” includes, for example, bisphenol compounds having general formula (XIV) as follows:

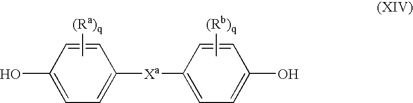

wherein R^{a} and R^{b} each represent a monovalent hydrocarbon group and may be the same or different; p and q are each independently integers from 0 to 4; and X^{a} represents one of the groups of formula (XV):

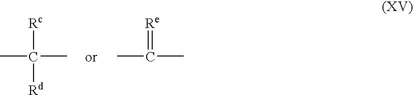

wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the dihydroxy-substituted aromatic hydrocarbons disclosed by name or formula (generic or specific) in U.S. Pat. No. 4,217,438. A nonexclusive list of specific examples of the types of bisphenol compounds that may be represented by formula (XIV) includes the following: 1,1-bis(4-hydroxyphenyl) methane; 1,1-bis(4-hydroxyphenyl) ethane; 2,2-bis(4-hydroxyphenyl) propane (hereinafter “bisphenol A” or “BPA”); 2,2-bis(4-hydroxyphenyl) butane; 2,2-bis(4-hydroxyphenyl) octane; ,1-bis(4-hydroxyphenyl) propane; 1,1-bis(4-hydroxyphenyl) n-butane; bis(4-hydroxyphenyl) phenylmethane; 2,2-bis(4-hydroxy-1-methylphenyl) propane; 1,1-bis(4-hydroxy-t-butylphenyl) propane; 1,1-bis(4-hydroxyphenyl) cyclopentane; and 1,1-bis(4-hydroxyphenyl) cyclohexane.

It is also possible to employ two or more different dihydric phenols or a copolymer of a dihydric phenol with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates may be prepared by adding a branching agent during polymerization.

These branching agents are well known and may comprise polyfunctional organic compounds containing at least three functional groups which may be hydroxyl, carboxyl, carboxylic anhydride, haloformyl and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha,alpha-dimethyl benzyl)phenol), 4-chloroformyl phthalic anhydride, trimesic acid and benzophenone tetracarboxylic acid. The branching agents may be added at a level of about 0.05 to about 2.0 weight percent. Branching agents and procedures for making branched polycarbonates are described in U.S. Pat. Nos. 3,635,895 and 4,001,184 which are incorporated by reference. All types of polycarbonate end groups are contemplated.

Preferred polycarbonates are based on bisphenol A, in which each of A¹ and A² is p-phenylene and Y¹ is isopropylidene. Preferably, the weight average molecular weight of the polycarbonate is about 5,000 to about 100,000, more preferably about 10,000 to about 65,000, and most preferably about 15,000 to about 35,000.

Polycarbonate is present in amounts of about 10 to about 90 weight percent, based on the total weight of the composition. Within this range, the amount of polycarbonate is preferably less than or equal to about 60, more preferably less than or equal to about 45 and most preferably less than or equal to about 30 weight percent.

The polyimides of formula (I) and the polyetherimides of formula (V) may be copolymerized with polysiloxanes, to form polyimide-polysiloxane copolymers. Polysiloxanes have the formula

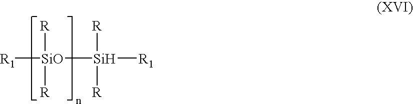

wherein R is the same or different C₍₁₋₁₄₎ monovalent hydrocarbon radical or C₍₁₋₁₄₎ monovalent hydrocarbon radical substituted with radicals inert during polycondensation or displacement reactions. The integer n ranges from about 1 to about 200. The reactive end group R¹ may be any functionality capable of reacting with the reactive endgroups on the polyimide of formula (I) or the polyetherimide of formula (V). Numerous reactive end groups are known, and include, for example, halogen atoms; lower dialkylamino groups of from 2 to about 20 carbon atoms; lower acyl groups of from 2 to about 20 carbon atoms; lower alkoxy of from 2 to about 20 carbon atoms; and hydrogen. U.S. Pat. No. 3,539,657 to Noshay et al. discloses certain siloxane-polyarylene polyether block copolymers, and describes, in general and specific terms, numerous siloxane oligomers having reactive end groups. Particularly preferred siloxane oligomers are those in which R¹ represents a dimethylamino group, an acetyl group or a chlorine atom.

The polyimide-siloxane copolymers may be block or graft copolymers wherein the polyimide oligomer and the siloxane oligomer are employed in substantially equimolar amounts; e.g., the molar ratio of the polyimide oligomer to the siloxane oligomer ranges from about 0.8:1 to about 1.2:1, preferably from about 0.9:1 to about 1.1:1. The reaction between the polyimide oligomer and the siloxane oligomer may be conducted under etherification conditions. Such conditions include a substantially anhydrous, organic reaction medium and an elevated temperature. The temperature advantageously ranges from about 100° C. to about 225° C., preferably from about 150° C. to about 200° C. The reaction is conducted in an inert organic solvent, and preferred solvents are the non-polar aprotic and polar aprotic solvents. A particularly preferred reaction solvent is o-dichlorobenzene.

Polyimide-siloxane copolymer is present in amounts of about 1 to about 20 weight percent, based on the total weight of the composition. Within this range, the amount of polyimide-siloxane copolymer is preferably greater than or equal to about 1.5, more preferably greater than or equal to about 1.75, and most preferably greater than or equal to about 2 weight percent. Also within this range, the amount of polyimide-siloxane copolymer is preferably less than or equal to about 18, more preferably less than or equal to about 13 and most preferably less than or equal to about 10 weight percent.

Talc is a common name for hydrous magnesium silicate. As discussed above the talc has an average particle size less than or equal to about 40 micrometers, preferably less than or equal to about 20 micrometers and more preferably less than or equal to about 10 micrometers. In some embodiments it is preferable for the talc to have an average particle size less than 1 micrometer and greater than or equal to 99% of the talc particles to have a particle size less than or equal to 2 micrometers. In other embodiments it is preferable for the talc to have an average particle size less than 10 micrometer and greater than or equal to 99% of the talc particles to have a particle size less than or equal to 20 micrometers. Talc is present in amounts of about 1 to about 30 weight percent, based on the total weight of the composition. Within this range, the amount of talc is preferably greater than or equal to about 3, more preferably greater than or equal to about 4, and most preferably greater than or equal to about 5 weight percent. Also within this range, the amount of talc is preferably less than or equal to about 25, more preferably less than or equal to about 20 and even more preferably less than or equal to about 15 weight percent, and most preferably less than or equal to about 12 weight percent.

The composition optionally comprises a colorant. Preferred colorants have good thermal stability under the melt processing conditions used to process the composition. In one embodiment, the mixture of resins, talc and colorants does not show significant color change during compounding, sheet extrusion and thermoforming and likewise does not show excessive decomposition of the resins (i.e. melt viscosity of the composition is not reduced by more than 35% by addition of the colorants under melt blending and subsequent thermal processing). Non limiting examples of colorants include titanium dioxide, zinc sulfide, zinc oxide, barium sulfate, carbon black, iron oxides, cobalt aluminates, chrome oxides, nickel titanates, molybdenum oxides, chrome copper oxides, ultramarine blue, phthalocyanines, quinacridones, perylenes, isoindolinones, and mixtures thereof. Other colorants such as pigment white 6, pigment black 7, pigment blue 29, pigment blue 28, pigment blue 36, pigment brown 33, pigment brown 24, solvent green 3, solvent green 28, pigment green 50, pigment blue 36, solvent orange 60, pigment orange 75, pigment red 101, pigment red 52, solvent red 52, solvent red 151, solvent violet 13, solvent violet 36, solvent yellow 33, pigment yellow 53, solvent red 179, solvent orange 63, solvent yellow 98, pigment red 179, pigment red 202, solvent red 236, solvent yellow 188, pigment blue 15:4, pigment green 7 and combinations of the foregoing may be used in addition to or in place of the preceding colorants.

Colorant is present in amounts of about 0.1 to about 15 weight percent, based on the total weight of the composition. Within this range, the amount of talc is preferably greater than or equal to about 0.3, more preferably greater than or equal to about 0.7, and most preferably greater than or equal to about 1 weight percent. Also within this range, the amount of colorant is preferably less than or equal to about 12, more preferably less than or equal to about 9 and most preferably less than or equal to about 5 weight percent.

The compositions can also include effective amounts of at least one additive selected from the group consisting of anti-oxidants, drip retardants, visual effects additives, stabilizers, antistatic agents, plasticizers, lubricants, and mixtures thereof. These additives are known in the art, as are their effective levels and methods of incorporation. Effective amounts of the additives vary widely, but they are usually present in an amount up to about 30% or more by weight, based on the weight of the entire composition.

The composition is formed by combining the components under conditions suitable for the formation of an intimate blend. Some or all of the components may be dry blended first and then combined at a conditions sufficient to melt at least one of the polymeric components. The composition may then be pelletized or immediately formed into an article.

In another embodiment, a method of making an article comprises heating the thermoplastic composition described above to a temperature greater than or equal to its softening point, putting the softened thermoplastic composition into a mold, cooling the formed composition until it can support its own weight, and removing it from the mold. The article can be made by thermoforming, profile extrusion, blow molding or injection molding. In thermoforming the thermoplastic composition is in the form of a sheet and when heated to a temperature greater than or equal to the softening point the composition is fitted to a mold using positive or negative pressure. In injection molding and blow molding the composition is typically heated to a temperature sufficient for the composition to flow under pressure and injected into a mold. Determination of pressure and temperatures in injection molding and thermoforming is dependent, in part, upon mold size and shape and can be determined by of ordinary skill in the art without undue experimentation.

In some embodiments, the composition is substantially free of chlorine and bromine. Substantially free is defined herein as containing less than 0.01 weight percent chlorine or bromine, based on the total weight of the composition. The disclosed subject matter is further illustrated by the following non-limiting examples.

### EXAMPLES

The following examples were made using the following materials. PEI is a polyetherimide sold under the tradename ULTEM 1000 and available from GE Plastics. PEI Siloxane is a copolymer made from diamino-propyl capped dimethyl siloxane, bisphenol A dianhydride (BPA-DA) and meta phenylene diamine. It has approximately 30 wt % siloxane and is sold by GE Plastics under the tradename SILTEM. Polycarbonate (PC) is a bisphenol A polycarbonate sold under the tradename LEXAN 130 by GE Plastics.

### Examples 1-3 and Comparative Example A

The polymer blends described in Table 1 ere prepared by first dry-blending the components and then compounding using a 96 millimeter (mm) co-rotating twin-screw extruder. The barrel temperatures were in the range of 338 to 349 ° C. and the die temperature was 343° C. The speed of the screw was about 300 to 500 rotations per minute (rpm). The resulting blends in the form of pellets were then made into sheets with dimensions of 3.175 mm×1.21 meter (m) ×2.42 m using a single screw sheet extruder. Barrel temperatures were about 232 to 338° C. The screw speed was 20 rpm. The die was heated to a temperature of about 327 to 354° C. The sheet extruder was equipped with a roller that embossed a texture on one side of the sheet.

The sheets were then cut into smaller sections of 3.175 mm×0.61 m×0.61 m for use on a lab-scale thermoforming machine. Thermoformed parts were then produced using a tool with a draw of approximately 127 mm. Additionally, 3.175 mm×102 mm×102 mm plaques were cut from the larger sheets for use in Dynatup impact testing.

Gloss measurements at 60 degrees, following ASTM D523, were then taken on both sides of the extruded sheet, textured and non-textured, as well as on the textured side of the thermoformed part. Biaxial impact tests, in accordance with ASTM D3763, were performed on the smaller samples. The maximum load values from these measurements are provided in Table 1.

Comparative Example A, which does not contain talc, has a high gloss value on the untextured side prior to thermoforming. The sheet can be textured to give low gloss but that low gloss is lost during subsequent thermoforming process steps. The presence of a mineral colorant, titanium dioxide, at 3.4 weight percent has no effect on reducing gloss or retaining low gloss after thermoforming. Examples 1,2 and 3 show that with increasing amounts of talc (4.8 to 14.5 wt %) the untextured sheet has lower gloss and the talc containing sheets kept more of their low gloss when thermoformed.

Flammability testing was also performed on examples 2 and 3. Examples 2 and 3 were tested for two minutes heat release and peak heat release according to ASTM E906. The heat release data given in Table 1 are an average of three tests of each sample.

TABLE 1

| | A | 1 | 2 | 3 |
|---|---|---|---|---|
| PEI | 73.2 | 69.6 | 65.9 | 62.2 |
| PC | 19.3 | 18.3 | 17.4 | 16.4 |
| Polysiloxane-PEI copolymer | 3.9 | 3.7 | 3.5 | 3.3 |
| Talc | 0 | 4.8 | 9.6 | 14.5 |
| Tris(2,4-di-t-butylphenyl)phosphite | 0.1 | 0.1 | 0.1 | 0.1 |
| Titanium Dioxide | 3.4 | 3.4 | 3.4 | 3.4 |
| Carbon Black | 0.03 | 0.03 | 0.03 | 0.03 |
| Solvent Red 135 | 0.03 | 0.03 | 0.03 | 0.03 |
| (Tetrachlorophthaloperinone) | | | | |
| Solvent Violet 13 (1-hydroxy-4-(p- | 0.03 | 0.03 | 0.03 | 0.03 |
| toluidino)-9,10-anthraquinone) | | | | |
| Pigment Yellow 24 | 0.05 | 0.05 | 0.05 | 0.05 |
| (Nickel Chrome Titanate) | | | | |
| 60 deg Gloss | | | | |
| Untextured side | 67 | 61 | 50 | 27 |
| Textured side | 22 | 16 | 12 | 10 |
| Thermoformed Textured side | 70 | 60 | 34 | 24 |
| Impact Properties | | | | |
| Biaxial impact Max Load (kg/m²) | 8837 | 9814 | 7558 | 1245 |
| OSU Heat Release | | | | |
| 2 min Heat Release (kW min/m²) | — | — | 4 | 5 |
| Peak Heat Release (kW min/m²) | — | — | 50 | 55 |

### Examples 4-6

The polymer blends described in Table 2 were prepared by first dry blending and then compounding using a vacuum vented 2.5″ single screw extruder. The barrel temperatures were 343° C. and the die temperature was 349° C. The screw speed was 100 rpm.

The resulting pellets were then injection molded into standard ASTM test parts for gloss and impact measurements using a 250 ton molding machine. A barrel temperature of 343° C. and a mold temperature of 121° C. were used for all molding.

Gloss and biaxial impact measurements were taken as above using ASTM D523 and D3763, respectively. Izod impact testing was carried out according to ASTM D256. Values for unnotched and reverse-notched Izod impact are reported in Table 2.

Note that comparative example B with the mineral colorant titanium dioxide has good impact strength but high gloss, which is unacceptable for many applications where reflected light is objectionable. The addition of talc reduced gloss. Examples 5 and 6 demonstrate that use of a talc with a small particle size (0.9 and 0. 5 micrometer) results in superior impact properties when compared to the larger particle size talc (9.0 micrometers, Example 4).

TABLE 2
Effect of talc particle size

| | Examples | | | |
|---|---|---|---|---|
| | B | 4 | 5 | 6 |
| PEI | 72.6 | 69.0 | 69.0 | 69.0 |
| PC | 19.1 | 18.2 | 18.2 | 18.2 |
| Polysiloxane-PEI copolymer | 3.8 | 3.6 | 3.6 | 3.6 |
| Talc (9.0 microns) | | 4.8 | | |
| Talc (0.9 microns) | | | 4.8 | |
| Talc (0.5 microns) | | | | 4.8 |
| Tris(2,4-di-t-butylphenyl)phosphite | 0.1 | 0.1 | 0.1 | 0.1 |
| Titanium Dioxide | 4.2 | 4.2 | 4.2 | 4.2 |
| Pigment Blue 29 (Sodium | 0.08 | 0.08 | 0.08 | 0.08 |
| aluminosulpho-silicate) | | | | |
| 60 deg Gloss | | | | |
| Injection-molded disks | 114 | 59.9 | 53.4 | 56.0 |
| Impact Properties | | | | |
| Unnotched Izod (fl-lbs/in) | 40.6 | 28.7 | 39.6 | 40.5 |
| Reverse Notched Izod (ft-lbs/in) | 40.6 | 22.0 | 40.6 | 36.7 |
| Biaxial impact Max Load (kg/m²) | 9277 | 8739 | 9325 | 9423 |

### Examples 7-10

The polymer blends described in Table 3 were prepared by first dry blending and then compounding using a vacuum vented 63.5 mm single screw extruder. The barrel temperatures were 343° C. and the die temperature was 349° C. The screw speed was 100 rpm.

The resulting pellets were then injection molded into standard ASTM test parts for gloss and impact measurements using a 250 ton molding machine. A barrel temperature of 343° C. and a mold temperature of 121° C. were used for all molding.

Gloss and biaxial impact measurements were taken as above using ASTM D523 and D3763, respectively. Izod impact testing was carried out according to ASTM D256. Values for unnotched and reverse-notched Izod impact are reported in Table 3. Comparative Example B contains no talc and has high gloss. Examples 7-10 show the effect of increasing talc content on lowering gloss.

The heat deflection temperature was measured according to ASTM D648, using a pressure of 264 psi on a sample 3.175 mm in thickness. These results, in degrees Celsius and given in Table 3, show that the heat deflection increases with the addition of talc.

TABLE 3
Gloss and impact vs. talc loading

| | Examples | | | | |
|---|---|---|---|---|---|
| | B | 7 | 8 | 9 | 10 |
| PEI | 72.6 | 70.8 | 65.4 | 61.7 | 58.1 |
| PC | 19.1 | 18.7 | 17.2 | 16.3 | 15.3 |
| Polysiloxane-PEI | 3.8 | 3.7 | 3.4 | 3.3 | 3.1 |
| copolymer | | | | | |
| Talc (0.9 micron) | 0 | 2.4 | 9.6 | 14.4 | 19.1 |
| Tris(2,4-di-t- | 0.1 | 0.1 | 0.1 | 0.1 | 0.1 |
| butylphenyl)phosphite | | | | | |
| Titanium Dioxide | 4.2 | 4.2 | 4.2 | 4.2 | 4.2 |
| Pigment Blue 29 | 0.08 | 0.08 | 0.08 | 0.08 | 0.08 |
| (Sodium aluminosulpho- | | | | | |
| silicate) | | | | | |
| 60 deg Gloss | | | | | |
| Injection-molded disks | 114 | 75 | 24 | 21 | 21 |
| Impact Properties | | | | | |
| Unnotched Izod ft-lbs/in | 40.6 | 39.1 | 31.0 | 10.2 | 7.5 |
| Reverse Notched Izod ft- | 40.6 | 40.6 | 24.2 | 8.4 | 4.7 |
| lbs/in | | | | | |
| Biaxial Impact, Max | 9277 | 9765 | 9325 | 1323 | 1230 |
| Load (kg/m²) | | | | | |
| Thermal properties | | | | | |
| HDT (0.125″, 264 psi) | 180 | 183 | 182 | 187 | 187 |

### Examples 11-14

The polymer blends described in Table 4 were prepared by first dry blending and then compounding using a vacuum vented 63.5 mm single screw extruder. The barrel temperatures were 343° C. and the die temperature was 349° C. The screw speed was 100 rpm.

The resulting pellets were injection molded into standard ASTM test parts for gloss and impact measurements using a 250 ton molding machine. A barrel temperature of 343° C. and a mold temperature of 121° C. were used for all molding.

Gloss and biaxial impact measurements were taken as above using ASTM D523 and D3763, respectively. Izod impact testing was carried out according to ASTM D256. Values for unnotched and reverse-notched Izod impact are reported in Table 4. Examples 11-14 show that variation in the amount of PC and PEI siloxane copolymer all give low gloss blends. Higher levels of polycarbonate give better impact strength (examples 11 vs. 12).

TABLE 4

| | 11 | 12 | 13 | 14 |
|---|---|---|---|---|
| PEI | 80.1 | 70.4 | 64.6 | 70.4 |
| PC | 9.7 | 19.3 | 9.7 | 9.7 |
| Polysiloxane-PEI copolymer | 1.9 | 1.9 | 7.7 | 1.9 |
| Talc (0.9 micron) | 4.8 | 4.8 | 14.5 | 14.5 |
| Tris(2,4-di-t- | 0.1 | 0.1 | 0.1 | 0.1 |
| butylphenyl)phosphite | | | | |
| Titanium Dioxide | 3.4 | 3.4 | 3.4 | 3.4 |
| 60 deg Gloss | | | | |
| Injection-molded disks | 38 | 45 | 18 | 15 |
| Impact Properties | | | | |
| Unnotched Izod | 31.3 | 33.7 | 7.7 | 9.9 |
| Reverse Notched Izod | 25.1 | 40.4 | 5.8 | 7.2 |
| Biaxial Impact, Max Load | 6494 | 8056 | 1377 | 1191 |
| (kg/m²) | | | | |

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A thermoplastic composition comprising a polyimide resin, a polycarbonate resin, a polyimide-polysiloxane copolymer and about 1 to about 30 weight percent talc based on the total weight of the composition, wherein the composition has a biaxial impact maximum load greater than or equal to about 975 kilograms per square meter, as measured by ASTM D3763 and a sixty degree gloss less than or equal to about 70, as measured by ASTM D523.

2. The composition of claim 1, wherein the composition has a two minute heat release of less than or equal to about 10 kilowatt minutes per square meter, as determined by ASTM E906.

3. The composition of claim 1, wherein the composition has a peak heat release of less than or equal to about 60 kilowatt minutes per square meter, as determined by ASTM E906.

4. The composition of claim 1, wherein the talc has an average particle size less than or equal to about 40 micrometers and greater than or equal to about 99% of the talc particles are less than or equal to about 50 micrometers.

5. The composition of claim 1, wherein the composition comprises about 10 to about 90 weight percent polyimide, based on the total weight of the composition.

6. The composition of claim 1, wherein the composition comprises about 10 to about 90 weight percent polycarbonate, based on the total weight of the composition.

8. The composition of claim 1, wherein the composition comprises about 1 to about 20 weight percent of the polyimide-polysiloxane copolymer, based on the total weight of the composition.

9. The composition of claim 1, further comprising about 0.1 to about 15 weight percent of a colorant.

10. The composition of claim 1, wherein the composition has a heat distortion value greater than or equal to about 170° C. at 264 psi, as determined by ASTM D648.

11. The composition of claim 1, wherein the composition has an NBS smoke density value less than or equal to about 10, as determined by ASTM E662.

12. The composition of claim 1, wherein the polyimide is a polyetherimide.

13. The composition of claim 1, wherein the composition comprises less than 0.01 weight percent chlorine or bromine, based on the total weight of the composition.

14. A method of making an article comprising
heating a thermoplastic composition above its softening point;
putting the softened thermoplastic composition into a mold to make the article, wherein the thermoplastic composition comprises a polyimide resin, a polycarbonate resin, a polyimide-polysiloxane copolymer and about 1 to about 30 weight percent talc based on the total weight of the composition, and the article has a biaxial impact maximum load greater than or equal to about 975 kilograms per square meter, as measured by ASTM D3763 and a sixty degree gloss less than or equal to about 70, as measured by ASTM D523;
cooling the article until its is capable of supporting its own weight; and
removing the article from the mold.

15. The method of claim 14, wherein the softened thermoplastic composition is injected into a mold under pressure in the molten state.

16. The method of claim 14, wherein the softened thermoplastic composition is in the form of a sheet and is shaped into the article by application of pressure.

17. A thermoformed article comprising
about 35 to about 75 weight percent of a polyimide resin;
about 10 to about 30 weight percent of a polycarbonate resin;
about 2 to about 10 weight percent of a polyimide-polysiloxane copolymer; and
about 5 to about 12 weight percent talc, wherein all weights are based on the total weight of the composition and further wherein the composition has a biaxial impact maximum load greater than or equal to about 4,880 kilograms per square meter, as measured by ASTM D3763 and a sixty degree gloss less than or equal to about 70, as measured by ASTM D523.

18. The composition of claim 17, wherein the talc has an average particle size less than or equal to about 40 micrometers and greater than or equal to about 99% of the talc particles are less than or equal to about 50 micrometers.

19. The composition of claim 17, wherein the talc has an average particle size less than or equal to about 10 micrometer and greater than or equal to about 99% of the talc particles are less than or equal to about 20 micrometers.

20. The composition of claim 17, wherein the talc has an average particle size less than or equal to about 1 micrometer and greater than or equal to about 99% of the talc particles are less than or equal to about 2 micrometers.

21. The composition of claim 17, wherein the polyimide is a polyetherimide.

22. The composition of claim 17, wherein the composition comprises less than 0.01 weight percent chlorine or bromine, based on the total weight of the composition.
